(19) United States
(12) Patent Application Publication
(10) Pub. No.: US 2015/0332034 A1
(43) Pub. Date: Nov. 19, 2015

(54) Spatial Audio Apparatus

(71) Applicant: NOKIA CORPORATION, Espoo (FI)

(72) Inventors: Roope Olavi Järvinen, Lempäälä (FI); Kari Juhani Järvinen, Tampere (FI); Miikka Tapani Vilermo, Siuro (FI); Juha Henrik Arrasvuori, Tampere (FI)

(21) Appl. No.: 14/651,794

(22) PCT Filed: Dec. 21, 2012
(86) PCT No.: PCT/IB2012/057624

§ 371 Date: Jun. 12, 2015

(51) Int. Cl. G06F 21/32; H04R 3/00; H04R 1/40; G10L 17/22; G10L 17/00

(52) U.S. Cl. CPC G06F 21/32; G10L 17/22; G10L 17/005; H04R 1/406; H04R 3/005; G06F 2221/2111; H04R 2430/20; H04R 2499/11

(57) ABSTRACT

An apparatus comprising: an input configured to receive at least one of: at least two audio signals from at least two microphones; and a network setup message; an analyser configured to authenticate at least one user from the input; a determiner configured to determine the position of the at least one user from the input; and an actuator configured to perform an action based on the authentication of the at least one user and/or the position of the at least one user.

### FIELD

The present application relates to apparatus for spatial audio signal processing applications. The invention further relates to, but is not limited to, apparatus for spatial audio signal processing within mobile devices.

### BACKGROUND

It would be understood that in the near future it will be possible for mobile apparatus such as mobile phones to have more than two microphones. This offers the possibility to record and process multichannel audio. With advanced signal processing it is further possible to beamform or directionally analyse the audio signal from the microphones from specific or desired directions.

Furthermore mobile apparatus are able to communicate or connect with other mobile apparatus in an attempt to produce a rich communication environment. Connections such as Bluetooth radio amongst others can be used to communicate data between mobile apparatus.

### SUMMARY

Aspects of this application thus provide a spatial audio capture and processing whereby listening orientation or video and audio capture orientation differences can be compensated for.

According to a first aspect there is provided an apparatus comprising: an input configured to receive at least one of: at least two audio signals from at least two microphones; and a network setup message; an analyser configured to authenticate at least one user from the input; a determiner configured to determine the position of the at least one user from the input; and an actuator configured to perform an action based on the authentication of the at least one user and/or the position of the at least one user.

The analyser may comprise: an audio signal analyser configured to determine at least one voice parameter from at least one of: the at least two audio signals, and the network setup message; and a voice authenticator configured to authenticate the at least one user based on the at least one voice parameter.

The determiner may comprise a positional audio signal analyser configured to determine at least one audio source and an associated audio source position parameter from at least one of: the at least two audio signals, and the network setup message, wherein the audio source is the at least one user.

The actuator may comprise a graphical representation determiner configured to determine a suitable graphical representation of the at least one user.

The graphical representation determiner may be further configured to determine a position on a display to display the suitable graphical representation based on the position of the at least one user.

The actuator may comprise a message generator configured to generate a message based on the at least one user and/or the position of the user.

The apparatus may comprise an output configured to output the message based on the at least one user and/or the position of the user to at least one further apparatus.

The message may comprise a network setup message comprising at least one of: an identifier for authenticating at least one user; and an associated audio source positional parameter, wherein the audio source is the at least one user.

The message may comprise an execution message configured to control a further apparatus actuator.

The message may comprise at least one of: a file transfer message configured to transfer a file to the at least one authenticated user; a file display message configured to transfer a file to the further apparatus and to be displayed to the at least one authenticated user; and a user identifier message configured to transfer to the further apparatus at least one credential associated with the at least one authenticated user to be displayed at the further apparatus for identifying the at least one user.

The actuator may comprise a message receiver configured to read and execute a message based on the at least one user and/or the position of the user, wherein the message comprises an execution message configured to control the actuator.

The execution message may comprise at least one of: a file transfer message configured to route a received file to the at least one authenticated user; a file display message configured to display a file to the at least one authenticated user; and a user identifier message configured to display at least one credential associated with at least one authenticated user for identifying the at least one user.

The apparatus may comprise a user input configured to control the actuator.

The apparatus may comprise a touch screen display and wherein the user input may be a user input from the touch screen display.

The determiner may be configured to determine the direction of the at least one user from the input relative to at least one of: the apparatus; and at least one further user.

According to a second aspect there is provided an apparatus comprising at least one processor and at least one memory including computer code for one or more programs, the at least one memory and the computer code configured to with the at least one processor cause the apparatus to at least: receive at least one of: at least two audio signals from at least two microphones; and a network setup message; authenticate at least one user from the input; determine the position of the at least one user from the input; and perform an action based on the authentication of the at least one user and/or the position of the at least one user.

Authenticating at least one user from the input may cause the apparatus to: determine at least one voice parameter from at least one of: the at least two audio signals, and the network setup message; and authenticate the at least one user based on the at least one voice parameter.

Determining the position of the at least one user from the input may cause the apparatus to determine at least one audio source and an associated audio source position parameter from at least one of: the at least two audio signals, and the network setup message, wherein the audio source is the at least one user.

Performing an action based on the authentication of the at least one user and/or the position of the at least one user may cause the apparatus to determine a suitable graphical representation of the at least one user.

Determining a suitable graphical representation of the at least one user may further cause the apparatus to determine a position on a display to display the suitable graphical representation based on the position of the at least one user.

Performing an action based on the authentication of the at least one user and/or the position of the at least one user may cause the apparatus to generate a message based on the at least one user and/or the position of the user.

The apparatus may be further caused to output the message based on the at least one user and/or the position of the user to at least one further apparatus.

The message may comprise a network setup message comprising at least one of: an identifier for authenticating at least one user; and an associated audio source positional parameter, wherein the audio source is the at least one user.

The message may comprise an execution message, wherein the execution message may be caused to control a further apparatus performing an action based on the authentication of the at least one user and/or the position of the at least one user.

The message may comprise at least one of: a file transfer message wherein performing an action based on the authentication of the at least one user and/or the position of the at least one user may cause a file to be transferred to the at least one authenticated user; a file display message wherein performing an action based on the authentication of the at least one user and/or the position of the at least one user may cause a file to be displayed to the at least one authenticated user; and a user identifier message wherein performing an action based on the authentication of the at least one user and/or the position of the at least one user may cause at least one credential associated with the at least one authenticated user to be displayed for identifying the at least one user.

Performing an action based on the authentication of the at least one user and/or the position of the at least one user may cause an apparatus to read and execute a message based on the at least one user and/or the position of the user, wherein the message comprises an execution message configured to control the performing of at least one further action.

The execution message may comprise at least one of: a file transfer message wherein performing an action based on the authentication of the at least one user and/or the position of the at least one user may cause the apparatus to route a received file to the at least one authenticated user; a file display message wherein performing an action based on the authentication of the at least one user and/or the position of the at least one user may cause the apparatus to display a file to the at least one authenticated user; and a user identifier message wherein performing an action based on the authentication of the at least one user and/or the position of the at least one user may cause the apparatus to display at least one credential associated with at least one authenticated user for identifying the at least one user.

The apparatus may be further caused to receive a user input, wherein the user input may cause the apparatus to control the performing an action based on the authentication of the at least one user and/or the position of the at least one user.

The apparatus may comprise a touch screen display wherein the user input is a user input from the touch screen display.

Determining the position of the at least one user from the input may cause the apparatus to determine the direction of the at least one user from the input relative to at least one of: the apparatus; and at least one further user.

According to a third aspect there is provided an apparatus comprising: means for receiving at least one of: at least two audio signals from at least two microphones; and a network setup message; means for authenticating at least one user from the input; means for determining the position of the at least one user from the input; and means for performing an action based on the authentication of the at least one user and/or the position of the at least one user.

The means for authenticating at least one user from the input may comprise: means for determining at least one voice parameter from at least one of: the at least two audio signals, and the network setup message; and means for authenticating the at least one user based on the at least one voice parameter.

The means for determining the position of the at least one user from the input may comprise means for determining at least one audio source and an associated audio source position parameter from at least one of: the at least two audio signals, and the network setup message, wherein the audio source is the at least one user.

The means for performing an action based on the authentication of the at least one user and/or the position of the at least one user may comprise means for determining a suitable graphical representation of the at least one user.

The means for determining a suitable graphical representation of the at least one user may further comprise means for determining a position on a display to display the suitable graphical representation based on the position of the at least one user.

The means for performing an action based on the authentication of the at least one user and/or the position of the at least one user may comprise means for generating a message based on the at least one user and/or the position of the user.

The apparatus may further comprise means for outputting the message based on the at least one user and/or the position of the user to at least one further apparatus.

The message may comprise a network setup message comprising at least one of: an identifier for authenticating at least one user; and an associated audio source positional parameter, wherein the audio source is the at least one user.

The message may comprise an execution message, wherein the execution message may comprise means for controlling a further apparatus means for performing an action based on the authentication of the at least one user and/or the position of the at least one user.

The message may comprise at least one of: a file transfer message wherein the means for performing an action based on the authentication of the at least one user and/or the position of the at least one user may comprise means for transferring a file to the at least one authenticated user; a file display message wherein the means for performing an action based on the authentication of the at least one user and/or the position of the at least one user may comprise means for displaying a file to the at least one authenticated user; and a user identifier message wherein the means for performing an action based on the authentication of the at least one user and/or the position of the at least one user may comprise means for displaying at least one credential associated with the at least one authenticated user for identifying the at least one user.

The means for performing an action based on the authentication of the at least one user and/or the position of the at least one user may comprise means for reading and means for executing a message based on the at least one user and/or the position of the user, wherein the message comprises an execution message configured to control the means for performing of at least one further action.

The execution message may comprise at least one of: a file transfer message wherein the means for performing an action based on the authentication of the at least one user and/or the position of the at least one user may comprise means for routing a received file to the at least one authenticated user; a file display message wherein the means for performing an action based on the authentication of the at least one user and/or the position of the at least one user may comprise means for displaying a file to the at least one authenticated user; and a user identifier message wherein the means for performing an action based on the authentication of the at least one user and/or the position of the at least one user may comprise means for displaying at least one credential associated with at least one authenticated user for identifying the at least one user.

The apparatus may comprise means for receiving a user input, wherein the means for receiving a user input may control the performing an action based on the authentication of the at least one user and/or the position of the at least one user.

The means for determining the position of the at least one user from the input may comprise means for determining the direction of the at least one user from the input relative to at least one of: the apparatus; and at least one further user.

According to a fourth aspect there is provided a method comprising: receiving at least one of: at least two audio signals from at least two microphones; and a network setup message; authenticating at least one user from the input; determining the position of the at least one user from the input; and performing an action based on the authentication of the at least one user and/or the position of the at least one user.

Authenticating at least one user from the input may comprise: determining at least one voice parameter from at least one of: the at least two audio signals, and the network setup message; and authenticating the at least one user based on the at least one voice parameter.

Determining the position of the at least one user from the input may comprise determining at least one audio source and an associated audio source position parameter from at least one of: the at least two audio signals, and the network setup message, wherein the audio source is the at least one user.

Performing an action based on the authentication of the at least one user and/or the position of the at least one user may comprise determining a suitable graphical representation of the at least one user.

Determining a suitable graphical representation of the at least one user may further comprise determining a position on a display to display the suitable graphical representation based on the position of the at least one user.

Performing an action based on the authentication of the at least one user and/or the position of the at least one user may comprise generating a message based on the at least one user and/or the position of the user.

The method may further outputting the message based on the at least one user and/or the position of the user to at least one apparatus.

The message may comprise a network setup message comprising at least one of: an identifier for authenticating at least one user; and an associated audio source positional parameter, wherein the audio source is the at least one user.

The message may comprise an execution message, wherein the execution message may control an apparatus performing an action based on the authentication of the at least one user and/or the position of the at least one user.

The message may comprise at least one of: a file transfer message wherein performing an action based on the authentication of the at least one user and/or the position of the at least one user may comprise transferring a file to the at least one authenticated user; a file display message wherein performing an action based on the authentication of the at least one user and/or the position of the at least one user may comprise displaying a file to the at least one authenticated user; and a user identifier message wherein performing an action based on the authentication of the at least one user and/or the position of the at least one user may comprise displaying at least one credential associated with the at least one authenticated user for identifying the at least one user.

Performing an action based on the authentication of the at least one user and/or the position of the at least one user may comprise reading and executing a message based on the at least one user and/or the position of the user, wherein the message comprises an execution message configured to control performing of at least one further action.

The execution message may comprise at least one of: a file transfer message wherein performing an action based on the authentication of the at least one user and/or the position of the at least one user may comprise routing a received file to the at least one authenticated user; a file display message wherein performing an action based on the authentication of the at least one user and/or the position of the at least one user may comprise displaying a file to the at least one authenticated user; and a user identifier message wherein performing an action based on the authentication of the at least one user and/or the position of the at least one user may comprise displaying at least one credential associated with at least one authenticated user for identifying the at least one user.

Receiving a user input may control the performing an action based on the authentication of the at least one user and/or the position of the at least one user.

Determining the position of the at least one user from the input may comprise determining the direction of the at least one user from the input relative to at least one of: an apparatus; and at least one further user.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For better understanding of the present application, reference will now be made by way of example to the accompanying drawings in which:

FIG. 1 shows schematically an apparatus suitable for being employed in some embodiments;

FIG. 2 shows schematically an example environment within which some embodiments can be implemented;

FIG. 3 shows schematically an example spatial audio signal processing apparatus according to some embodiments;

FIG. 4 shows schematically a summary flow diagram of the operation of spatial audio signal processing apparatus according to some embodiments;

FIG. 5 shows schematically a flow diagram of the operation of the spatial audio signal processing apparatus as shown in FIG. 3 with respect to setup operations according to some embodiments;

FIG. 6 shows schematically a flow diagram of the operation of the spatial audio signal processing apparatus as shown in FIG. 3 with respect to action message generation operations according to some embodiments;

FIG. 7 shows schematically a flow diagram of the operation of the spatial audio signal processing apparatus as shown in FIG. 3 with respect to action message receiving operations according to some embodiments; and

FIGS. 8 to 10 shows schematically example use cases of the example spatial audio signal processing apparatus according to some embodiments.

### EMBODIMENTS

The following describes in further detail suitable apparatus and possible mechanisms for the provision of effective directional analysis and authentication of audio recordings of voice for example within audio-video capture apparatus. In the following examples the recording/capture of audio signals and processing of audio signals are described. However it would be appreciated that in some embodiments the audio signal recording/capture and processing is part of an audio-video system.

As described herein mobile apparatus are more commonly being equipped with multiple microphone configurations or microphone arrays suitable for recording or capturing the audio environment (or audio scene) surrounding the mobile apparatus. The configuration or arrangement of the microphones on the apparatus or associated with the apparatus (in other words the microphones are configured with known relative locations and orientations) enables the apparatus to process the captured (or recorded) audio signals from the microphones to analyse using spatial processing audio sources and directions or orientations or audio sources, for example a voice or speaker.

Similarly the rich connected environment of modern communications apparatus enables mobile apparatus to share files or to exchange information of some form with each other with little difficulty. For example information can be communicated between apparatus identifying the user of specific apparatus and providing further detail on the user, such as business title, contact details and other credentials. A common mechanism for such communication is one where apparatus are contacted together to enable a near field communication (NFC) connection to transfer business or contact data. Similarly communication of data and files using short range ad hoc communication such as provided by Bluetooth or other short range communications protocols (IrDA etc) to set up ad hoc communication networks between apparatus are known. However these communication systems do not offer directional information and as such are unable to use directional information to address or direct messages. For example although Bluetooth signal strength can be used to detect which apparatus is the nearest one this typically is limited in terms of being used to direct a message to a particular user of a multiuser apparatus.

The concept of embodiments is to enable a setting up and monitoring of users of apparatus by user authentication through voice detection and directional detection in order to identify and locate a particular user with respect to at least one mobile apparatus and preferably multiple user apparatus arranged in an ad hoc group.

Where the users or persons in the audio scene have been authenticated and detected the relative spatial positions of these users can be determined and monitored, for example monitored continuously. The apparatus in close proximity can share these locations between each other. It would be understood that in some embodiments there can be more apparatus than users or vice versa.

Furthermore the authenticated and located users can then be represented by a graphical representation with relative spatial locations of each detected user on an apparatus display enabling the use of a graphical user interface to interact between users. For example in some embodiments the visual or graphical representations of the users can be used by other users to transfer files, by flicking a visual representation of a file towards the direction of a user on a graphical display or dragging and dropping the representation of the file in the direction of a user causing the apparatus to send the file to a second apparatus nearest the user and in some embodiments to a portion of the apparatus proximate to the user.

It is thus envisaged that some embodiments of the application will be implemented on large sized displays such as tablets, smart tables or displays projected on surfaces on which multiple users can interact at the same time as well as individually controlled apparatus such as tablets, personal computers, mobile communications apparatus.

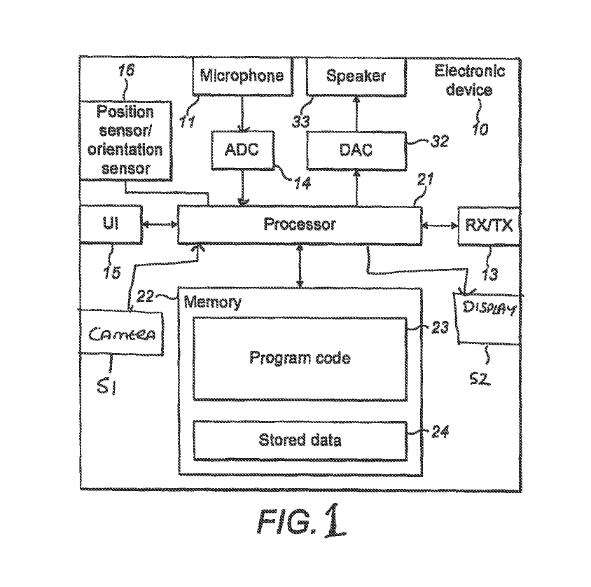

In this regard reference is first made to FIG. 1 which shows a schematic block diagram of an exemplary apparatus or electronic device 10, which may be used in some embodiments to record (or operate as a capture apparatus), to process, or generally operate within the environment as described herein.

The apparatus 10 may for example be a mobile terminal or user equipment of a wireless communication system when functioning as the recording apparatus or listening apparatus. In some embodiments the apparatus can be an audio player or audio recorder, such as an MP3 player, a media recorder/player (also known as an MP4 player), or any suitable portable apparatus suitable for recording audio or audio/video camcorder/memory audio or video recorder. The apparatus as described herein can in some embodiments be a personal computer, tablet computer, portable or laptop computer, a smart-display, a smart-projector, or other apparatus suitable for both recording and processing audio and displaying images.

The apparatus 10 can in some embodiments comprise an audio-video subsystem. The audio-video subsystem for example can comprise in some embodiments a microphone or array of microphones 11 for audio signal capture. In some embodiments the microphone or array of microphones can be a solid state microphone, in other words capable of capturing audio signals and outputting a suitable digital format signal. In some other embodiments the microphone or array of microphones 11 can comprise any suitable microphone or audio capture means, for example a condenser microphone, capacitor microphone, electrostatic microphone, Electret condenser microphone, dynamic microphone, ribbon microphone, carbon microphone, piezoelectric microphone, or micro electrical-mechanical system (MEMS) microphone. In some embodiments the microphone 11 is a digital microphone array, in other words configured to generate a digital signal output (and thus not requiring an analogue-to-digital converter). The microphone 11 or array of microphones can in some embodiments output the audio captured signal to an analogue-to-digital converter (ADC) 14.

In some embodiments the apparatus can further comprise an analogue-to-digital converter (ADC) 14 configured to receive the analogue captured audio signal from the microphones and outputting the audio captured signal in a suitable digital form. The analogue-to-digital converter 14 can be any suitable analogue-to-digital conversion or processing means. In some embodiments the microphones are ‘integrated’ microphones containing both audio signal generating and analogue-to-digital conversion capability.

In some embodiments the apparatus 10 audio-video subsystem further comprises a digital-to-analogue converter 32 for converting digital audio signals from a processor 21 to a suitable analogue format. The digital-to-analogue converter (DAC) or signal processing means 32 can in some embodiments be any suitable DAC technology.

Furthermore the audio-video subsystem can comprise in some embodiments a speaker 33. The speaker 33 can in some embodiments receive the output from the digital-to-analogue converter 32 and present the analogue audio signal to the user. In some embodiments the speaker 33 can be representative of multi-speaker arrangement, a headset, for example a set of headphones, or cordless headphones.

In some embodiments the apparatus audio-video subsystem comprises a camera 51 or image capturing means configured to supply to the processor 21 image data. In some embodiments the camera can be configured to supply multiple images over time to provide a video stream.

In some embodiments the apparatus audio-video subsystem comprises a display 52. The display or image display means can be configured to output visual images which can be viewed by the user of the apparatus. In some embodiments the display can be a touch screen display suitable for supplying input data to the apparatus. The display can be any suitable display technology, for example the display can be implemented by a flat panel comprising cells of LCD, LED, OLED, or ‘plasma’ display implementations. In some embodiments the display 52 is a projection display.

Although the apparatus 10 is shown having both audio/video capture and audio/video presentation components, it would be understood that in some embodiments the apparatus 10 can comprise one or the other of the audio capture and audio presentation parts of the audio subsystem such that in some embodiments of the apparatus the microphone (for audio capture) or the speaker (for audio presentation) are present. Similarly in some embodiments the apparatus 10 can comprise one or the other of the video capture and video presentation parts of the video subsystem such that in some embodiments the camera 51 (for video capture) or the display 52 (for video presentation) is present.

In some embodiments the apparatus 10 comprises a processor 21. The processor 21 is coupled to the audio-video subsystem and specifically in some examples the analogue-to-digital converter 14 for receiving digital signals representing audio signals from the microphone 11, the digital-to-analogue converter (DAC) 12 configured to output processed digital audio signals, the camera 51 for receiving digital signals representing video signals, and the display 52 configured to output processed digital video signals from the processor 21.

The processor 21 can be configured to execute various program codes. The implemented program codes can comprise for example audio signal capture and processing and video or graphical representation and presentation routines. In some embodiments the program codes can be configured to perform audio signal modeling or spatial audio signal processing.

In some embodiments the apparatus further comprises a memory 22. In some embodiments the processor is coupled to memory 22. The memory can be any suitable storage means. In some embodiments the memory 22 comprises a program code section 23 for storing program codes implementable upon the processor 21. Furthermore in some embodiments the memory 22 can further comprise a stored data section 24 for storing data, for example data that has been encoded in accordance with the application or data to be encoded via the application embodiments as described later. The implemented program code stored within the program code section 23, and the data stored within the stored data section 24 can be retrieved by the processor 21 whenever needed via the memory-processor coupling.

In some further embodiments the apparatus 10 can comprise a user interface 15. The user interface 15 can be coupled in some embodiments to the processor 21. In some embodiments the processor can control the operation of the user interface and receive inputs from the user interface 15. In some embodiments the user interface 15 can enable a user to input commands to the electronic device or apparatus 10, for example via a keypad, and/or to obtain information from the apparatus 10, for example via a display which is part of the user interface 15. The user interface 15 can in some embodiments as described herein comprise a touch screen or touch interface capable of both enabling information to be entered to the apparatus 10 and further displaying information to the user of the apparatus 10.

In some embodiments the apparatus further comprises a transceiver 13, the transceiver in such embodiments can be coupled to the processor and configured to enable a communication with other apparatus or electronic devices, for example via a wireless communications network. The transceiver 13 or any suitable transceiver or transmitter and/or receiver means can in some embodiments be configured to communicate with other electronic devices or apparatus via a wire or wired coupling.

The transceiver 13 can communicate with further apparatus by any suitable known communications protocol, for example in some embodiments the transceiver 13 or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IrDA).

In some embodiments the apparatus comprises a position sensor 16 configured to estimate the position of the apparatus 10. The position sensor 16 can in some embodiments be a satellite positioning sensor such as a GPS (Global Positioning System), GLONASS or Galileo receiver.

In some embodiments the positioning sensor can be a cellular ID system or an assisted GPS system.

In some embodiments the apparatus 10 further comprises a direction or orientation sensor. The orientation/direction sensor can in some embodiments be an electronic compass, accelerometer, and a gyroscope or be determined by the motion of the apparatus using the positioning estimate.

It is to be understood again that the structure of the electronic device 10 could be supplemented and varied in many ways.

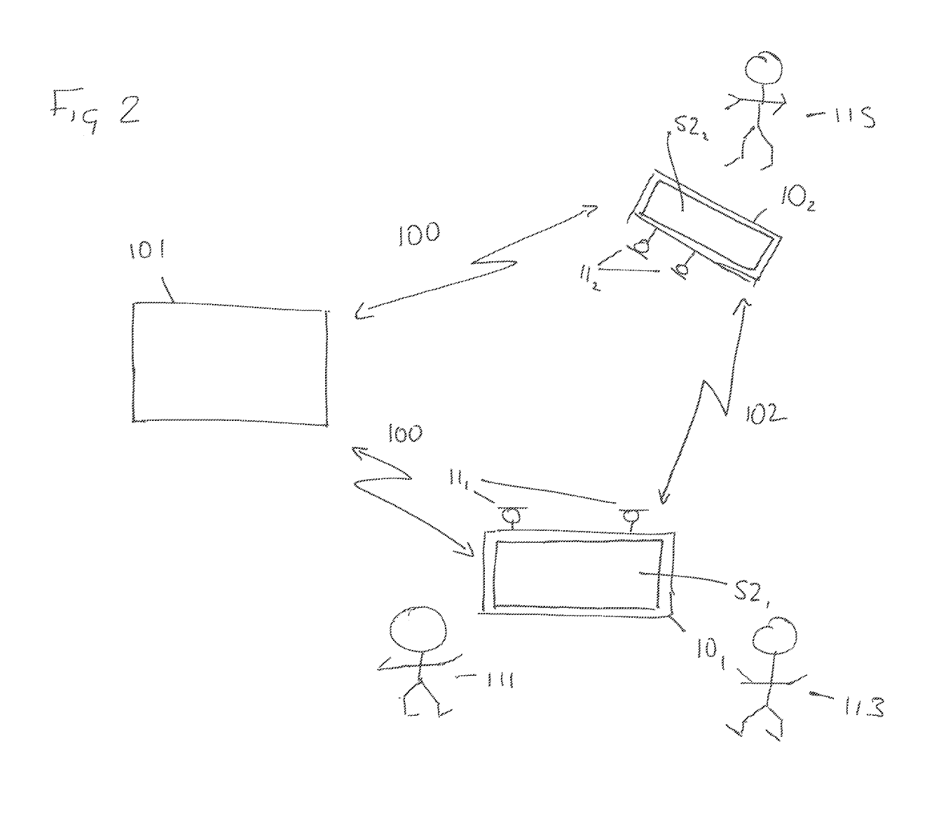

With respect to FIG. 2 an example environment in which apparatus as shown in FIG. 1 is shown. The environment shown in FIG. 2 shows three differing apparatus, however it would be understood that in some embodiments more than or fewer than three apparatus can be used.

In the example shown in FIG. 2 there comprises a first apparatus 10₁ comprising a display 52₁ and a microphone array 11₁ configured to communicate to a second apparatus 10₂ by a first communication link 102 and further configured to communicate with a smart-projector or smart large screen display 101 via a ‘projector’ communications link 100. In the examples described herein the first apparatus 10₁ is a large tablet computer operated by a two users concurrently, a first user (user A) 111 located relative to the left-hand side of the first apparatus 10₁, and a second user (user B) 113 located relative to the right hand side of the first apparatus 10₁.

The environment also comprises a second apparatus 10₂ comprising a display 52₂ and microphone array 11₂ configured to communicate with the first apparatus 10₁ via the communication link 102 and further configured to communicate with a smart-projector or smart large screen display 101 via a ‘projector’ communications link 100. Furthermore the second apparatus 10₂ is operated by a third user (user C) 115 located centrally with respect to the second apparatus 10₂.

Furthermore the apparatus environment shows a ‘pure’ or smart-display or smart-projector apparatus 101 configured to communicate with the first apparatus 10₁ and second apparatus 10₂ via the ‘projector’ communications link 100.

The environment as shown in FIG. 2 thus shows that the environments within which apparatus can operate can comprise apparatus of various capabilities in terms of display technology, microphones and user input apparatus.

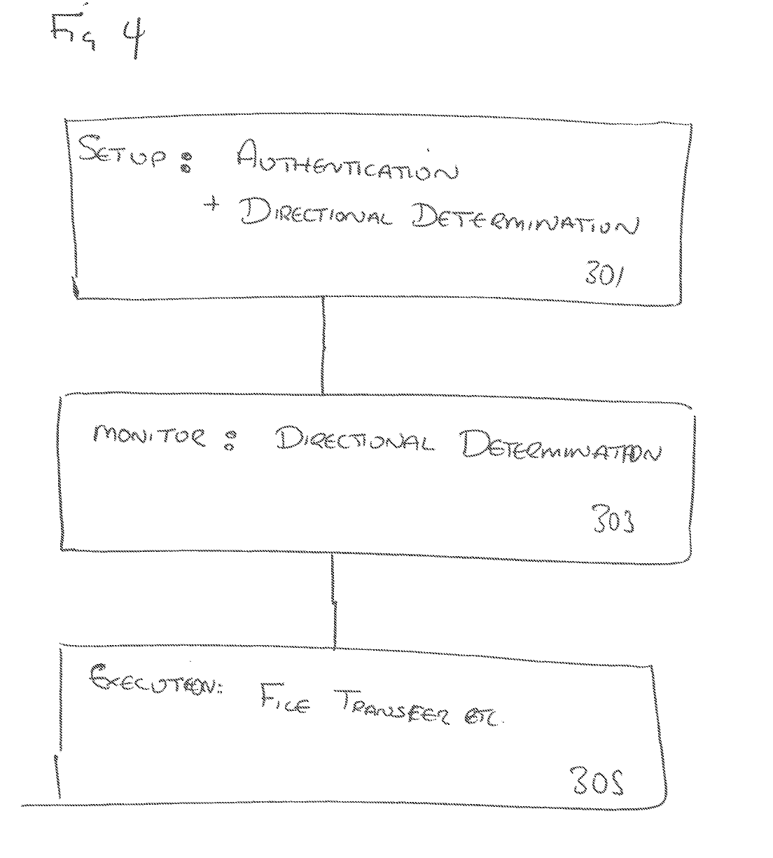

With respect to FIG. 4 an example summary operation flowchart showing the implementation of some embodiments is shown with respect to the environment shown in FIG. 2. Thus for example the first apparatus 10₁ and the second apparatus 10₂ are configured to record or capture the audio signals in the environment and in particular the voices of users of the apparatus 10₁ and 10₂. In some embodiments the first apparatus 10₁, the second apparatus 10₂ or a combination of the first and second apparatus can be configured to ‘set up’ or initialise the visual representation of the ‘audio’ environment enabling communication and permitting data can be exchanged. This initialisation or ‘set up’ operation comprises at least one of the first apparatus 10₁ and second apparatus 10₂ (in other words apparatus comprising microphones) being configured to authenticate and directionally determine the relative positions of the users from their voices. For example in some embodiments both the first apparatus 10₁ and the second apparatus 10₂ are configured to record and capture the audio signals of the environment, authenticate the voice signal of each user within the environment as they speak and determine the relative direction or location of the users in the environment relative to at least one of the apparatus.

In some embodiments the apparatus can be configured to generate a message (for example a ‘set up’ message) containing this information to other apparatus. In some embodiments other apparatus receive this information (‘set up’ messages) and authenticates this information against its own voice authentication and direction determination operations.

In some embodiments the apparatus can further be configured to generate a visual or graphical representation of the users and displays this information on the display.

The operation of setting up the communication environment is shown in FIG. 4 by step 301.

Furthermore in some embodiments the apparatus can be configured to monitor the location or direction of each of the authenticated users. In some embodiments this monitoring can be continuous for example whenever the user speaks, and thus the apparatus can be able to locate the user even where the user moves about.

The operation of monitoring the directional component is shown in FIG. 4 by step 303.

In some embodiments the apparatus having set up and monitored the positions of the users, can use this positional and identification information in user-based interaction and execution of user-based interaction applications or programs. For example the apparatus can be configured to transfer a file from a user A operating the first apparatus to the user B operating the second apparatus by ‘flicking’ a representation of a file on the display of the first apparatus towards the direction of user C (or the visual representation of user C).

The operation of executing a user interaction such as file transfer is shown in FIG. 4 by step 305.

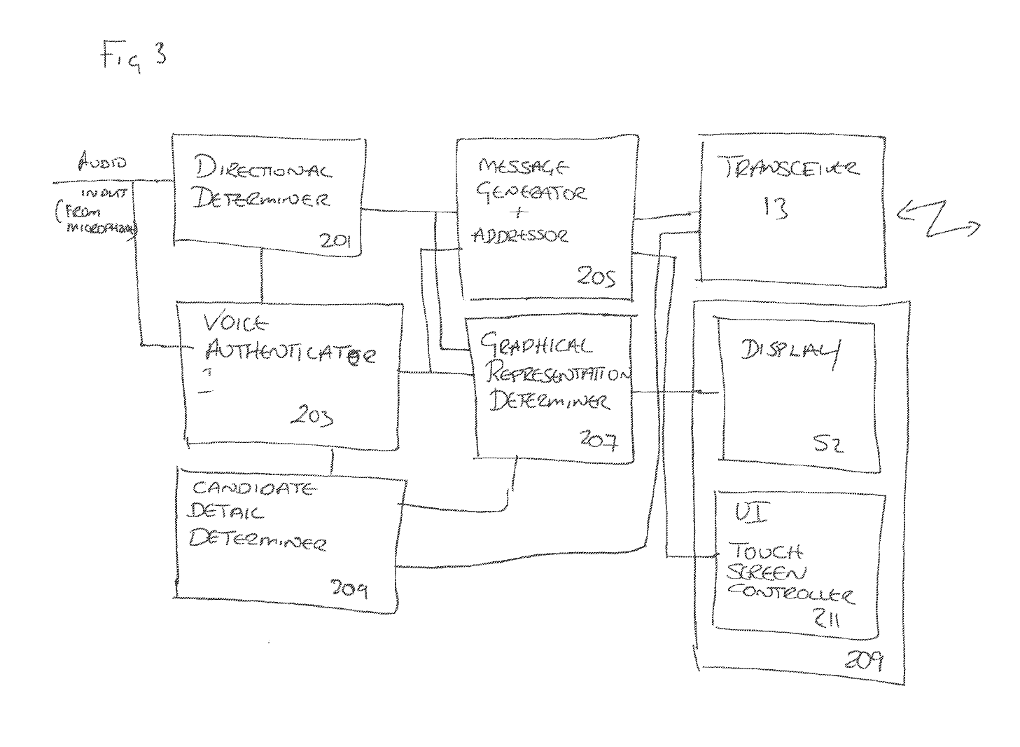

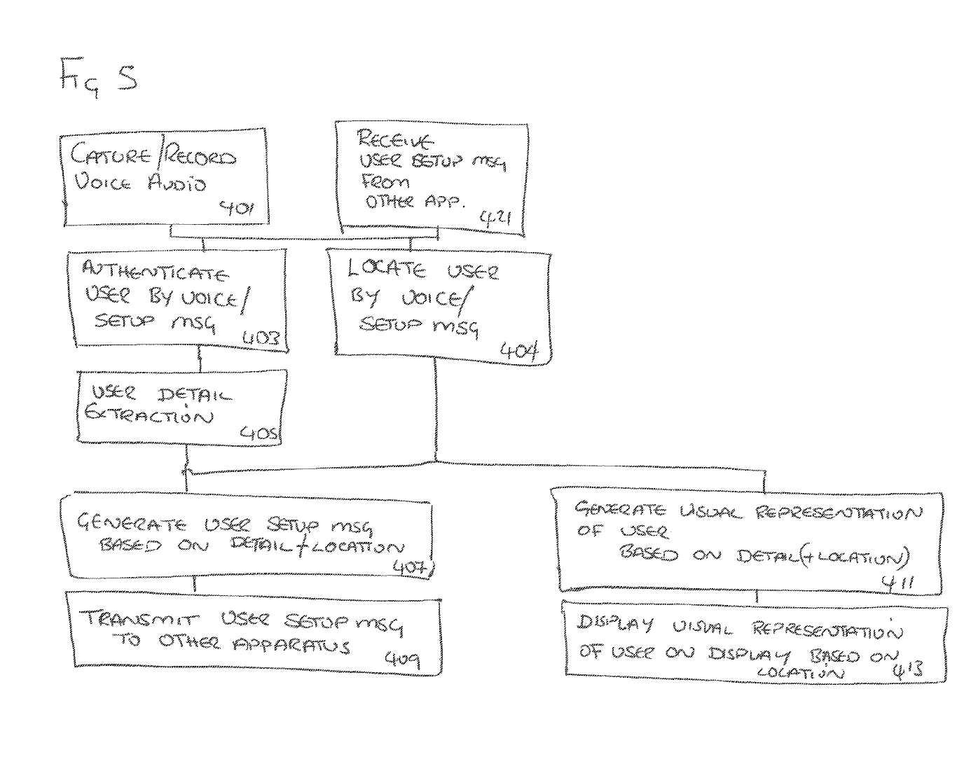

With respect to FIG. 3 a detailed example of an apparatus suitable for operating in the environment as shown in FIG. 2 according to some embodiments. Furthermore with respect to FIGS. 5 to 7 are shown flow diagrams of example operations of the apparatus shown in FIG. 3 according to some embodiments.

In some embodiments the apparatus comprises microphones such as shown in FIGS. 1 and 2. The microphone arrays can in some embodiments be configured to record or capture audio signals and in particular the voice of any users operating the apparatus. In some embodiments the apparatus is associated with microphones which are not coupled physically or directly on the apparatus from which audio signals can be received via an input.

The operation of capturing or recording the voice audio signals for the users of the apparatus is shown in FIG. 5 by step 401.

In some embodiments the apparatus comprises an analyser configured to analyse the audio signals and authenticate at least one user based on the audio signal. The analyser can in some embodiments comprise an audio signal analyser and voice authenticator 203. The analyser comprising the audio signal analyser and voice authenticator 203 can be configured to receive the audio signals from the microphones and are configured to authenticate the received audio signal or voice signals with defined (or predefined) user voice print or suitable voice tag identification features. For example in some embodiments the analyser comprising the audio signal analyser and voice authenticator 203 can be configured to check the received audio signals, determine a spectral frequency distribution for the audio signals and compare the spectral frequency distribution against a stored user voice spectral frequency distribution table to identifies the user. It would be understood that in some embodiments any suitable voice authentication operation can be implemented.

The analyser comprising the audio signal analyser and voice authenticator 203 can in some embodiments be configured to output an indicator of the identified user (the user authenticated) to one or more of a candidate detail determiner 209, a graphical representation determiner 207, or a message generator and address 205.

The operation of authenticating the user by voice is shown in FIG. 5 by step 403.

In some embodiments the apparatus comprises a candidate detail determiner 209. The candidate detail determiner 209 can in some embodiments be configured to receive an identifier from the voice authenticator 203 identifying a speaking user. The candidate detail determiner 209 can then be configured in some embodiments to retrieve details or information concerning the user associated with the user identifier.

For example in some embodiments the candidate detail determiner 209 can determine or retrieve information concerning the user such as an electronic business card (vCard), social media identifiers such as Facebook address, Twitter feed, a digital representation of the user such as a facebook picture, linked in picture, Xbox avatar, and information about which apparatus the user is currently using such as MAC addresses, SIM identification, SIP addresses or network addresses. Any suitable information can be retrieved either internally, such as from the memory of the apparatus or externally, for example from other apparatus or generally from any suitable network.

The candidate detail determiner 209 can in some embodiments output information or detail on the user to at least one of: a message generator and addresser 205, a graphical representation determiner 207, or to a transceiver 13.

The operation of extracting the user detail based on the authenticated user ID is shown in FIG. 5 by step 405.

In some embodiments the apparatus comprises a positional determiner or directional determiner 201 or suitable means for determining a position of at least one user. The directional determiner can in some embodiments be configured to determine the directional or relative position of components of the audio sources for example the user's voice. In some embodiments the directional determiner 201 can be configured to determine the relative location or orientation of the audio source relative to a direction other than the apparatus by using a further sensor to determine an absolute or reference orientation. For example a compass or orientation sensor can be used to determine the relative orientation of the apparatus to a reference orientation and thus the absolute orientation of the audio source (such as the user's voice relative to the reference orientation).

An example spatial analysis, determination of sources and parameterisation of the audio signal is described as follows. However it would be understood that any suitable audio signal spatial or directional analysis in either the time or other representational domain (frequency domain etc.) can be used.

In some embodiments the directional determiner 201 comprises a framer. The framer or suitable framer means can be configured to receive the audio signals from the microphones and divide the digital format signals into frames or groups of audio sample data. In some embodiments the framer can furthermore be configured to window the data using any suitable windowing function. The framer can be configured to generate frames of audio signal data for each microphone input wherein the length of each frame and a degree of overlap of each frame can be any suitable value. For example in some embodiments each audio frame is 20 milliseconds long and has an overlap of 10 milliseconds between frames. The framer can be configured to output the frame audio data to a Time-to-Frequency Domain Transformer.

In some embodiments the directional determiner 201 comprises a Time-to-Frequency Domain Transformer. The Time-to-Frequency Domain Transformer or suitable transformer means can be configured to perform any suitable time-to-frequency domain transformation on the frame audio data. In some embodiments the Time-to-Frequency Domain Transformer can be a Discrete Fourier Transformer (DFT). However the Transformer can be any suitable Transformer such as a Discrete Cosine Transformer (DCT), a Modified Discrete Cosine Transformer (MDCT), a Fast Fourier Transformer (FFT) or a quadrature mirror filter (QMF). The Time-to-Frequency Domain Transformer can be configured to output a frequency domain signal for each microphone input to a sub-band filter.

In some embodiments the directional determiner 201 comprises a sub-band divider. The sub-band divider or suitable means can be configured to receive the frequency domain signals from the Time-to-Frequency Domain Transformer for each microphone and divide each microphone audio signal frequency domain signal into a number of sub-bands.

The sub-band division can be any suitable sub-band division. For example in some embodiments the sub-band filter can be configured to operate using psychoacoustic filtering bands. The sub-band filter can then be configured to output each domain range sub-band to a direction analyser.

In some embodiments the directional determiner 201 can comprise a direction analyser. The direction analyser or suitable means can in some embodiments be configured to select a sub-band and the associated frequency domain signals for each microphone of the sub-band.

The direction analyser can then be configured to perform directional analysis on the signals in the sub-band. The directional analyser can be configured in some embodiments to perform a cross correlation between the microphone/decoder sub-band frequency domain signals within a suitable processing means.

In the direction analyser the delay value of the cross correlation is found which maximises the cross correlation of the frequency domain sub-band signals. This delay can in some embodiments be used to estimate the angle or represent the angle from the dominant audio signal source for the sub-band. This angle can be defined as α. It would be understood that whilst a pair or two microphones can provide a first angle, an improved directional estimate can be produced by using more than two microphones and preferably in some embodiments more than two microphones on two or more axes.

The directional analyser can then be configured to determine whether or not all of the sub-bands have been selected. Where all of the sub-bands have been selected in some embodiments then the direction analyser can be configured to output the directional analysis results. Where not all of the sub-bands have been selected then the operation can be passed back to selecting a further sub-band processing step.

The above describes a direction analyser performing an analysis using frequency domain correlation values. However it would be understood that the direction analyser can perform directional analysis using any suitable method. For example in some embodiments the object detector and separator can be configured to output specific azimuth-elevation values rather than maximum correlation delay values.

Furthermore in some embodiments the spatial analysis can be performed in the time domain.

In some embodiments this direction analysis can therefore be defined as receiving the audio sub-band data;

xₖ^{b}(n)=xₖ(n_{b}+n), n=0, . . . , n_{b+1}−n_{b}−1, b=0, . . . , B−1

where n_{b} is the first index of bth subband. In some embodiments for every subband the directional analysis as described herein as follows. First the direction is estimated with two channels. The direction analyser finds delay τ_{b} that maximizes the correlation between the two channels for subband b. DFT domain representation of e.g. xₖ^{b}(n) can be shifted τ_{b} time domain samples using

$$\text{?} = ( n ) = \text{?} ( n ) {e}^{- j \frac{\text{?}}{\text{?}}} . \\ \text{?} \text{indicates text missing or illegible when filed}$$

The optimal delay in some embodiments can be obtained from

$$\text{?} Re ( \text{?} ( \text{?} ( n ) \text{?} ( n ) ) ) , {τ}_{b} ∈ [ - {D}_{tor} \cdot {D}_{tot} ]$$

$$\text{?} \text{indicates text missing or illegible when filed}$$

where Re indicates the real part of the result and * denotes complex conjugate. x_{2,τ}_{_{b}}^{b} and x₂^{b} are considered vectors with length of n_{b+1}−n_{b} samples. The direction analyser can in some embodiments implement a resolution of one time domain sample for the search of the delay.

In some embodiments the direction analyser can be configured to generate a sum signal. The sum signal can be mathematically defined as.

$${X}_{sum}^{b} = \{ \begin{matrix}( \text{?} + \text{?} ) / 2 & {τ}_{b} \leq 0 \\ ( {X}_{2}^{b} + \text{?} ) / 2 & {τ}_{b} > 0\end{matrix} \\ \text{?} \text{indicates text missing or illegible when filed}$$

It would be understood that the delay or shift τ_{b} indicates how much closer the sound source is to one microphone (or channel) than another microphone (or channel). The direction analyser can be configured to determine actual difference in distance as

$$\text{?} = \frac{v {τ}_{b}}{\text{?}}$$

$$\text{?} \text{indicates text missing or illegible when filed}$$

where Fs is the sampling rate of the signal and v is the speed of the signal in air (or in water if we are making underwater recordings).

The angle of the arriving sound is determined by the direction analyser as,

$${d}_{b} = \pm {cos}^{- 1} ( \frac{\text{?} + 2 b \text{?} - {d}^{2}}{2 db} )$$

$$\text{?} \text{indicates text missing or illegible when filed}$$

where d is the distance between the pair of microphones/channel separation and b is the estimated distance between sound sources and nearest microphone. In some embodiments the direction analyser can be configured to set the value of b to a fixed value. For example b=2 meters has been found to provide stable results.

It would be understood that the determination described herein provides two alternatives for the direction of the arriving sound as the exact direction cannot be determined with only two microphones/channels.

In some embodiments the direction analyser can be configured to use audio signals from a third channel or the third microphone to define which of the signs in the determination is correct. The distances between the third channel or microphone and the two estimated sound sources are:

δ_{b}⁺={square root over ((h+b sin(\dot{α}_{b}))²+(\dot{α}/2+b cos(\dot{α}_{b}))²)}

δ_{b}⁻={square root over ((h−b sin(\dot{α}_{b}))²+(\dot{α}/2+b cos(\dot{α}_{b}))²)}

where h is the height of an equilateral triangle (where the channels or microphones determine a triangle), i.e.

$$h = \frac{\sqrt{\text{?}}}{\text{?}} \text{?} . \\ \text{?} \text{indicates text missing or illegible when filed}$$

The distances in the above determination can be considered to be equal to delays (in samples) of;

$${τ}_{b}^{+} = \frac{{δ}^{+} - b}{v} \text{?}$$

$${τ}_{b}^{-} = \frac{{δ}^{-} - b}{v} \text{?}$$

$$\text{?} \text{indicates text missing or illegible when filed}$$

Out of these two delays the direction analyser in some embodiments is configured to select the one which provides better correlation with the sum signal. The correlations can for example be represented as

$${c}_{b}^{+} = Re ( {\sum }_{n = 0}^{{n}_{b + 1} - {n}_{b} - 1} ( \text{?} ( n ) \text{?} ( n ) ) )$$

$${c}_{b}^{-} = Re ( {\sum }_{n = 0}^{{n}_{b + 1} - {n}_{b} - 1} ( \text{?} ( n ) \text{?} ( n ) ) )$$

$$\text{?} \text{indicates text missing or illegible when filed}$$

The direction analyser can then in some embodiments then determine the direction of the dominant sound source for subband b as:

$${α}_{b} = \{ \begin{matrix}\text{?} & {c}_{b}^{+} \geq {c}_{b}^{-} \\ - {\dot{α}}_{b} & {c}_{b}^{+} < {c}_{b}^{-}\end{matrix} . \\ \text{?} \text{indicates text missing or illegible when filed}$$

The direction (α) components of the captured audio signals can be output to message generator 205, graphical representation determiner 207 or any suitable audio object processor.

The operation of processing the audio signals and locating (and separating) the user by voice determination is shown in FIG. 5 by step 404.

In some embodiments the apparatus comprises an actuator configured to perform an action based on the authentication of the at least one user and/or the position of the at least one user. The action can for example be determining or generating a graphical representation, generating a message to a further apparatus or controlling the apparatus based on a received message.

In some embodiments the apparatus comprises a graphical representation determiner 207. The graphical (or visual) representation determiner 207 can in some embodiments be configured to receive from the voice authenticator 203 a user identification value indicating the user speaking, from the candidate detail determiner 209 further details of the user to be displayed, and from the directional determiner 201 a relative position or orientation of the user.

The graphical representation determiner 207 can then be configured to generate a visual or graphical representation of the user. In some embodiments the visual or graphical representation of the user is based on the detail provided by the candidate detail determiner 209, for example an avatar or icon representing the user. In some embodiments the graphical representation determiner 207 can be configured to generate a graphical or visual representation of the user at a particular location on the display based on the location or orientation as determined by the directional determiner 201. For example in some embodiments the graphical representation determiner 207 is configured to generate a user identification value graphical representation on a ‘radar map’ which is centred on the current apparatus or at some other suitable centre or reference location.

In some embodiments the graphical representation determiner 207 can be configured to output the graphical (or visual) representation to a suitable display such as the touch screen device display 209 comprising the display 52 shown in FIG. 3.

The operation of generating a graphical (or visual) representation of the user based on the detail or/and location is shown in FIG. 5 by step 411.

In some embodiments the apparatus comprises a display 52 configured to receive the graphical (or visual) representation and display on display the visual representation of the user, for example an icon representing the user at an approximation of the position of the user. Thus for example with respect to the apparatus shown in FIG. 2, the first apparatus 10₁ can in some embodiments be configured to display a graphical (or visual) representation of user A to the bottom left of the display, user B to the bottom right of the display and user C at the top of the display. Similarly the second apparatus 10₂ can in some embodiments be configured to display graphical (or visual) representations of user A to the top right of the display and user B to the top left of the display (which would reflect the orientation of the apparatus) and user C to the bottom of the display.

The operation of displaying the visual representation of the user on the display is shown in FIG. 5 by step 413.

In some embodiments the apparatus comprises a message generator and address 205. The message generator and addresser 205 or any suitable message handler or handler means can be configured to output (or generate) a message. In some embodiments the message generator can be configured to generate a user ‘set up’ or initialisation message. The user ‘set up’ or initialization message can be generated using the received information from the analyser comprising the audio signal analyser and voice authenticator 203 indicating the authenticated user, information from the directional determiner 201 indicating the relative orientation or direction of the authenticated voice user and in some embodiments detail from the candidate detail determiner 209 (for example identifying the current apparatus or device from which the apparatus is operating from). The message generator and addresser 205 can then be configured to output the user ‘set up’ or initialization message to the transceiver 13.

The operation of generating a user ‘set up’ message based on the user identification/detail/location is shown in FIG. 5 by step 407.

In some embodiments the transceiver can be configured to receive the message and transmit the user ‘set up’ message to other apparatus. In some embodiments the user ‘set up’ message is broadcast to all other apparatus within a short range communications link range. In some embodiments the ‘set up’ message is specifically a user identification ‘set up’ message for an already determined ad hoc network of apparatus.

The operation of transmitting the user ‘set up’ message to other apparatus is shown in FIG. 5 by step 409. It would be understood that a network ‘set up’ can be a network of two apparatus. Furthermore the network can in some embodiments be any suitable coupling between the apparatus, including but not exclusively wireless local area network (WLAN), Bluetooth (BT), Infrared data (IrDA), near field communication (NFC), short message service messages (SMS) over cellular communications etc. In some such embodiments the message can for example transfer device or apparatus specific codes which can be used to represent a user. In such a manner in some embodiments the users are recognised (by their devices or apparatus) and the position determined for example through audio signal processing.

Furthermore in some embodiments although the directional determiner 201 and analyser comprising the audio signal analyser and voice authenticator 203 are configured to operate independently of other apparatus in some embodiments the directional determiner 201 and analyser comprising the audio signal analyser and voice authenticator 203 can be configured to operate in co-operation with other apparatus. For example in some embodiments the apparatus transceiver 13 can be configured to receive a user ‘set up’ or initialisation message from another apparatus.

The ‘set up’ or initialisation message from another apparatus can in some embodiments be passed to the message generator and address 205 to be processed, parsed and the relevant information from the ‘set up’ message passed to the directional determiner 201, the analyser comprising the audio signal analyser and voice authenticator 203 and the graphical representation determiner 207 in a suitable manner.

The operation of receiving from other apparatus a user ‘set up’ message is shown in FIG. 5 by step 421.

For example in some embodiments the ‘set up’ message voice authentication information can be passed by the message generator and addresser 205 to the analyser comprising the audio signal analyser and voice authenticator 203. This additional information can be used to assist the analyser comprising the audio signal analyser and voice authenticator 203 in identifying the users in the audio scene.

Similarly the ‘set up’ message directional information from other apparatus can be used by the determiner 201 to generate a positional determination of an identified voice audio source, for example position relative to the apparatus (or position relative to a further user) and in some embodiments to enable a degree of triangulation where the location of at least two apparatus and relative orientation from apparatus is known.

It would be understood that in these embodiments the use of the user ‘set up’ or initialization message can thus further trigger the extraction of user detail, the generation of further user ‘set up’ messages and the generation of graphical (or visual) representations of the user.

It would be understood that in some embodiments the directional determiner 201 and analyser comprising the audio signal analyser and voice authenticator 203 can maintain a monitoring operation of the user(s) within the area by monitoring the voices and positions or directions of the voices (for example a position relative to the apparatus) and communicating this to other apparatus in the ad-hoc network.

Furthermore it would be understood that the message generator and addresser 205 and graphical representation determiner 207 can further be used in such a monitoring operation by communicating with other apparatus and displaying the graphical (or visual) representation of the users on the display.

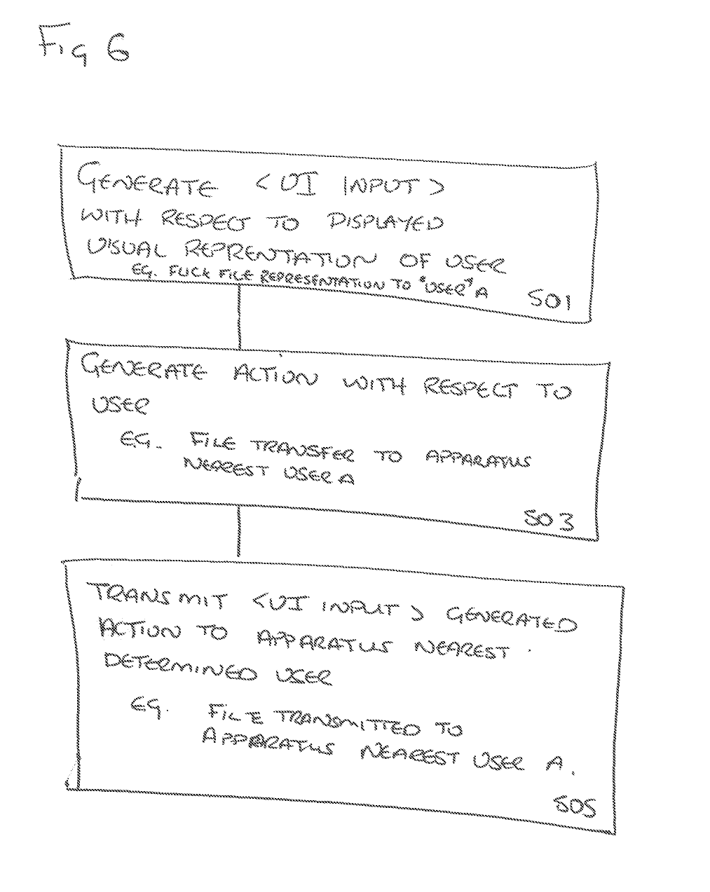

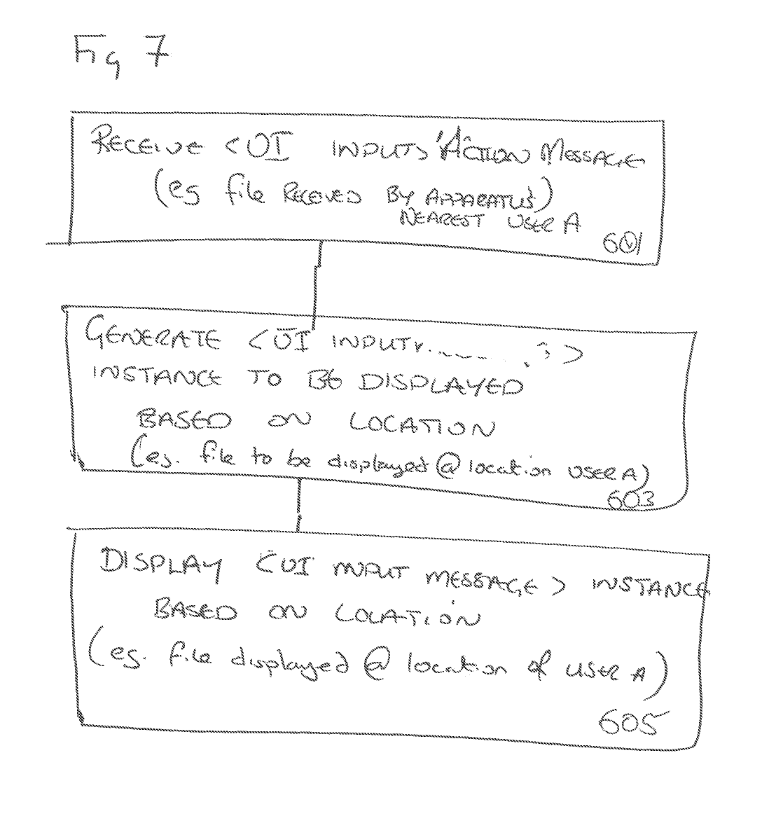

With respect to FIGS. 6 and 7 an example execution or application execution using the information determined by the setup process is described in further detail.

In some embodiments the touch screen assembly 209 comprises a user interface touchscreen controller 211. The user touchscreen controller 211 can in some embodiments generate a user interface input with respect to the displayed visual representation of users in the audio environment.

Thus for example using the situation in FIG. 2, user C 115 operating the second apparatus 10₂ can attempt to transfer a file to user A 111 operating the first apparatus 10₁ by ‘flicking’ a representation of a file on the display of the second apparatus towards the representation of user A (or generally touching the display at the representation of a file in the direction of user A). The touch screen controller 211 can pass the user interface message to the message generator and addresser 205 of the second apparatus 11₂.

The operation of generating a user interface input with respect to the displayed graphical representation of a user is shown in FIG. 6 by step 501.

The message generator and addresser 205 can in some embodiments then generate the appropriate action with respect to the user interface input. Thus for example the message generator and addresser 205 can be configured to retrieve the selected file, generate a message containing the file and address the message containing the file to be sent to user A of the first apparatus.

The operation of generating the action with respect to the user is shown in FIG. 6 by step 503.

The transceiver 13 can then receive the generated message and transmit the message triggered by the user interface input the appropriate apparatus. For example the generated message containing the selected file is sent to the first apparatus.

The operation of transmitting the UI input message generated action to the appropriate apparatus is shown in FIG. 6 by step 505.

With respect to FIG. 7 an example operation of receiving such a user interface input action message is described in detail.

In some embodiments the transceiver of the apparatus (for example the first apparatus) receives the UI input action message, for example the message containing the selected file (which has been sent by user C to user A).

The operation of receiving the UI input action message is shown in FIG. 7 by step 601.

The user interface input action message can then be processed by the message generator and addresser 205 (or suitable message handling means) which can for example be used to control the graphical representation determiner 207 to generate a user interface input instance on the display. For example in some embodiments the file or representation of the file sent to user A is displayed on the first apparatus. Furthermore in some embodiments where there are more than one user of the same apparatus the graphical representation determiner 207 can be configured to control the displaying of such information to the part or portion of the display closest to the user and so not disturb any other users unduly.

The operation of generating the UI input instance to be displayed is shown in FIG. 7 by step 603.

The display 52 can then be configured to display the UI input action message.

The operation of displaying the UI input action message instance image is shown in FIG. 7 by step 605

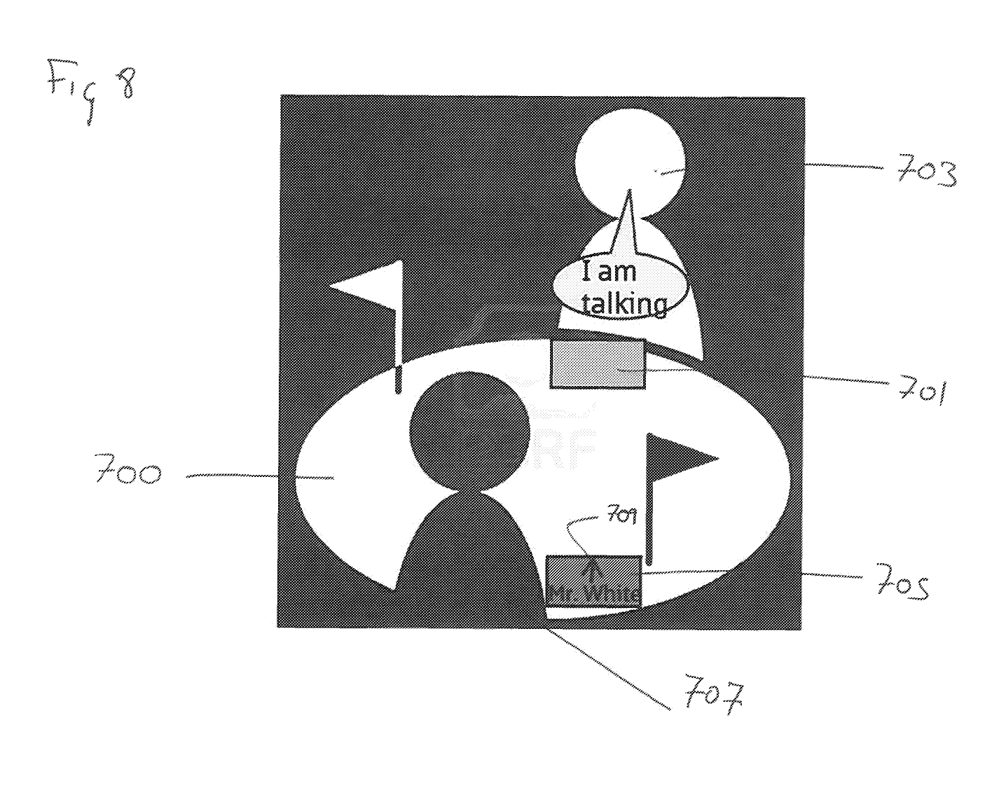

With respect to FIG. 8 an example use application of some embodiments are shown. In this first example the Blue apparatus 701 is configured to detect and authenticate its user (“Mr. White”) 703 as it is familiar with his speaking voice. The blue apparatus is then configured to transmit the identification or ‘tell the name’ of the confirmed user to the Red apparatus 705 opposite the blue apparatus 701 on the table 700. In such examples the red apparatus 705 detects by means of spatial audio capture the direction where the authenticated user 703 of Blue apparatus 701 is speaking. The red apparatus 705 can then be configured to indicate the name of the confirmed user 703 and shows with an arrow 709 the direction in which the user is talking. Furthermore should the user 707 of the red apparatus 705 wish to do so then the user 707 of the red apparatus 705 can touch or ‘flicks’ a file on the apparatus touch screen in that direction→709 and cause the red apparatus 705 to send the file to the Blue apparatus 701.

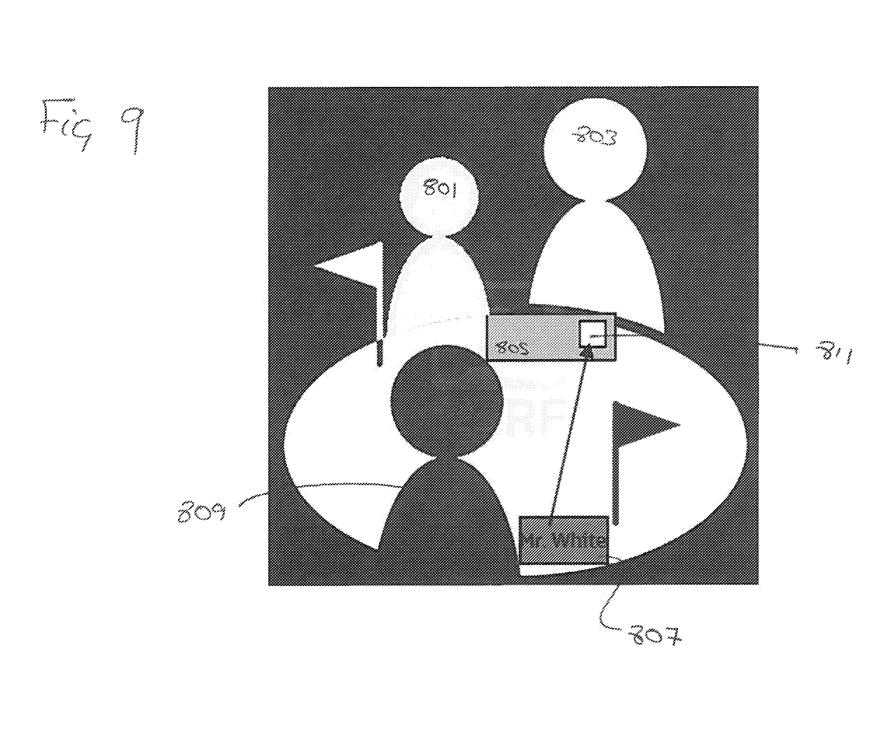

In the example shown in FIG. 9, two users, a first user (Mr. Yellow) 801 and a second user (Mr. White) 803 are speaking next to a large display such as a tablet (a blue apparatus) 805. This single apparatus 805 authenticates the two users and is configured to transmit identification (or show their names) and spatial positions on the separate apparatus 807 of a third user (Mr. Black) 809 who is seated opposite to the first and second users. Third user (Mr. Black) 809 wishes to send a file to the second user (Mr. White), so ‘flicks’ the file on his apparatus touch screen in the direction of the second user (Mr. White) 803. The tablet (Blue apparatus) 805 has determined or detects through analysis of the speaking voice of the second user 803 that the second user (Mr. White) 803 is on the right side of the device (relative to the third user) and the first user (Mr. Yellow) 801 is on the right side (when looking from the vantage point of the third user (Mr. Black) who is sending the file). Thus, the tablet 805 can be configured generate the representation of the received file 811 to appear on the tablet at the location where the second user (Mr. White) 803 is (rather than on the side where the first user (Mr. Yellow) 801 is).

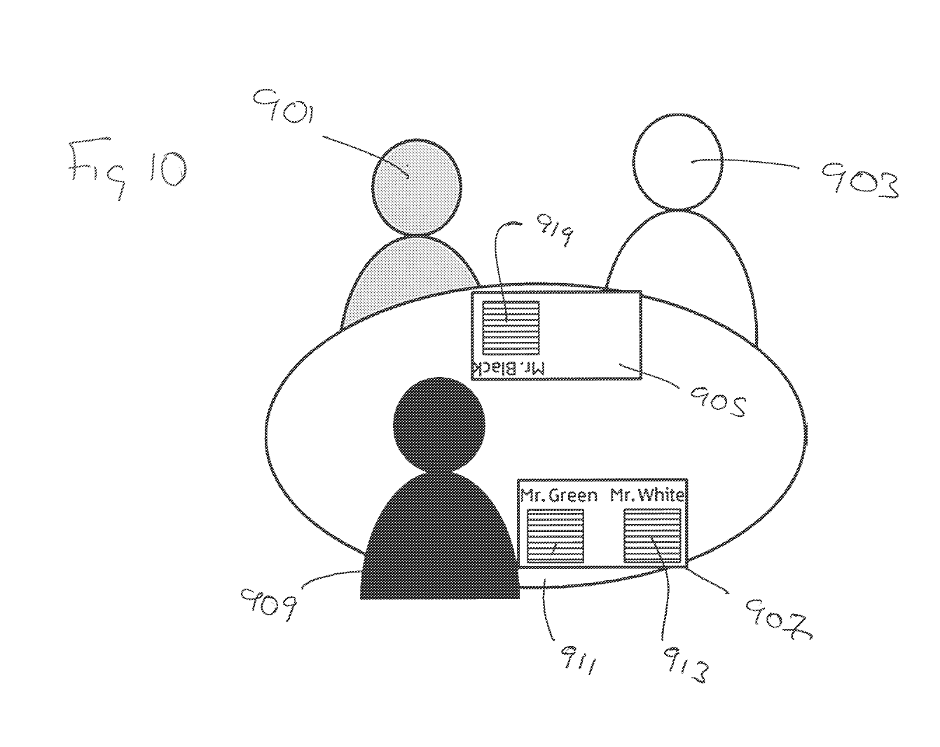

With respect to FIG. 10, two users, a first user (Mr. Green) 901 and a second user (Mr. White) 903 are speaking next to a large display such as a tablet or apparatus 905. This single apparatus 905 authenticates the two users and is configured to transmit identification (or show their names) and spatial positions on the separate apparatus 907 of a third user (Mr. Black) 909 who is seated opposite to the first and second users. Similarly the apparatus 907 of the third user 909 is configured to authenticate the user 909 and transmit identification and spatial positions to the table 905. In this example both the tablet 905 and separate apparatus 907 can be configured to show the names, the business cards, LinkedIn profiles, summaries of the recent publications etc. of the people who have been detected and authenticated to be talking around the table. Thus for example first user credentials 911 are displayed on the side of the display closest the first user 901 from the vantage point of the third user 909, and the second user credentials 913 are displayed on the side of the display closest the second user 903 from the vantage point of the third user 909. Similarly with respect to the tablet 905 the third user credentials 919 are displayed on the side of the display closest the third user 909 from the vantage point of the first and second users. In such an example the apparatus are configured to assume that the users around the table don't know each other, for example they determine that the table and apparatus have not been paired before, and are configured to show credential or background information about the users of the apparatus.

Although in the following examples the directional determination and voice authentication is shown with a separate analysis or processing stages it would be understood that in some embodiments each may utilise common elements.

It would be understood that the number of instances, types of instance and selection of options for the instances are all possible user interface choices and the examples shown herein are example user interface implementations only.

It shall be appreciated that the term user equipment is intended to cover any suitable type of wireless user equipment, such as mobile telephones, portable data processing devices or portable web browsers, as well as wearable devices.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-18. (canceled)

19. An apparatus comprising:
an input configured to receive at least one of: at least two audio signals from at least two microphones; and a network setup message;
an analyser configured to authenticate at least one user from the input;
a determiner configured to determine the position of the at least one user from the input; and
an actuator configured to perform an action based on the authentication of at least one of the at least one user and the position of the at least one user.

20. The apparatus as claimed in claim 19, wherein the analyser comprises:
an audio signal analyser configured to determine at least one voice parameter from at least one of: the at least two audio signals, and the network setup message; and
a voice authenticator configured to authenticate the at least one user based on the at least one voice parameter.

21. The apparatus as claimed in claim 19, wherein the determiner comprises a positional audio signal analyser configured to determine at least one audio source and an associated audio source position parameter from at least one of: the at least two audio signals, and the network setup message, wherein the audio source is the at least one user.

22. The apparatus as claimed in claim 19, wherein the actuator comprises a graphical representation determiner configured to determine a graphical representation of the at least one user.

23. The apparatus as claimed in claim 22, wherein the graphical representation determiner is further configured to determine a position on a display to display the suitable graphical representation based on the position of the at least one user.

24. The apparatus as claimed in claim 19, wherein the actuator comprises a message generator configured to generate a message based on at least one of the at least one user and the position of the user.

25. The apparatus as claimed in claim 24, comprising an output configured to output the message based on at least one of the at least one user and the position of the user to at least one further apparatus.

26. The apparatus as claimed in claim 24, wherein the message comprises a network setup message comprising at least one of:
an identifier for authenticating at least one user; and
an associated audio source positional parameter, wherein the audio source is the at least one user.

27. The apparatus as claimed in claim 24, wherein the message comprises an execution message configured to control a further apparatus actuator.

28. The apparatus as claimed in claim 24, wherein the message comprises at least one of:
a file transfer message configured to transfer a file to the at least one authenticated user;
a file display message configured to transfer a file to the further apparatus and to be displayed to the at least one authenticated user; and
a user identifier message configured to transfer to the further apparatus at least one credential associated with the at least one authenticated user to be displayed at the further apparatus for identifying the at least one user.

29. The apparatus as claimed in claim 19, wherein the actuator comprises a message receiver configured to read and execute a message based on at least one of the at least one user and the position of the user, wherein the message comprises an execution message configured to control the actuator.

30. The apparatus as claimed in claim 29, wherein the execution message comprises at least one of:
a file transfer message configured to route a received file to the at least one authenticated user;
a file display message configured to display a file to the at least one authenticated user; and a user identifier message configured to display at least one credential associated with at least one authenticated user for identifying the at least one user.

31. The apparatus as claimed in claim 19, comprising a touch screen display and wherein a user input configured to control the actuator and the user input is from the touch screen display.

32. The apparatus as claimed in claim 19, wherein the determiner is configured to determine the direction of the at least one user from the input relative to at least one of:
the apparatus; and
at least one further user.

33. An apparatus comprising at least one processor and at least one memory including computer code for one or more programs, the at least one memory and the computer code configured to with the at least one processor cause the apparatus to at least:
receive at least one of: at least two audio signals from at least two microphones; and a network setup message;
authenticate at least one user from the input;
determine the position of the at least one user from the input; and
perform an action based on the authentication of the at least one user and/or the position of the at least one user.

34. A method comprising:
receiving at least one of: at least two audio signals from at least two microphones; and a network setup message;
authenticating at least one user from the input;
determining the position of the at least one user from the input; and
performing an action based on the authentication of the at least one user and/or the position of the at least one user.

35. The method as claimed in claim 34, wherein authenticating at least one user from the input comprises: determining at least one voice parameter from at least one of: the at least two audio signals, and the network setup message; and authenticating the at least one user based on the at least one voice parameter.

36. The method as claimed in claim 34, wherein determining the position of the at least one user from the input comprises determining at least one audio source and an associated audio source position parameter from at least one of: the at least two audio signals, and the network setup message, wherein the audio source is the at least one user.

37. The method as claimed in claim 34, wherein performing an action based on the authentication of at least one of the at least one user and the position of the at least one user comprises determining a graphical representation of the at least one user.

38. The method as claimed in claim 37, wherein determining the graphical representation of the at least one user further comprises determining a position on a display to display the graphical representation based on the position of the at least one user.
